(19) United States
(12) Patent Application Publication
(10) Pub. No.: US 2026/0344728 A1
(43) Pub. Date: Nov. 5, 2026

(54) THREE-DIMENSIONAL FOOD PRINTER CAPABLE OF PROCESSING FLUID/PASTE TYPE FOOD

(71) Applicant: ISTANBUL TEKNIK UNIVERSITESI, Istanbul (TR)

(72) Inventors: Evren DEMIRCAN, Istanbul (TR); Beraat GUNSAR, Istanbul (TR)

(73) Assignee: ISTANBUL TEKNIK UNIVERSITESI, Istanbul (TR)

(21) Appl. No.: 19/488,104

(22) PCT Filed: May 24, 2024
(86) PCT No.: PCT/TR2024/050538

§ 371 Date: Nov. 26, 2025

(30) Foreign Application Priority Data
May 26, 2023 (TR) 2023/006090

(51) Int. Cl. A23P 20/20; A23P 20/25; B08B 3/12; B33Y 30/00

(52) U.S. Cl. CPC A23P 20/20; B08B 3/12; B33Y 30/00; A23P 2020/253

(57) ABSTRACT

The provided is an ultrasonication unit for cleaning food printing heads for additive manufacturing applications, in particular syringes used with such heads, and for homogenising the material contained in the syringe. Printing heads suitable for use with this ultrasonication unit, integration of the ultrasonication unit into a three-dimensional printer, and a rail structure for detachably attaching clamps securing the syringe to the printing head to allow the use of syringes of different sizes are also disclosed.

### TECHNICAL FIELD

The present invention relates to an ultrasonication unit for cleaning food printing heads for additive manufacturing applications.

### PRIOR ART

Some printers containing syringe-type extruders have been developed for the application of three-dimensional printing techniques with biological materials and foodstuffs, and various solutions have been proposed for cleaning the syringe after printing.

Document numbered CN115416283A discloses a three-dimensional printer and associated printing method for creating skin tissue models. The biological material is deposited by means of a syringe. Taking water several times from a cleaning tank in order to clean the syringe is also disclosed.

Document numbered KR102065474B1 discloses a three-dimensional printer for use with various biological materials. A cleaning unit for cleaning a nozzle unit is also disclosed. The cleaning unit is described as feeding water to the nozzle, applying vibration and applying vacuum. In the relevant figures, it is shown that the cleaning unit comprises grooves through which pipette mouths in the nozzle are immersed, and it is understood that the nozzle is cleaned by vibrations applied to a chamber under the grooves.

### OBJECTS OF THE INVENTION

The object of the present invention is the development of an ultrasonication unit for cleaning syringes used for additive manufacturing.

Another object of the present invention is the development of an ultrasonication unit for mixing and homogenising the material in syringes.

A further object of the present invention is the development of an ultrasonication unit that can be integrated into three-dimensional printers.

### DETAILED DESCRIPTION OF THE INVENTION

The ultrasonication unit realised to achieve the object of the present invention is shown in the accompanying figures.

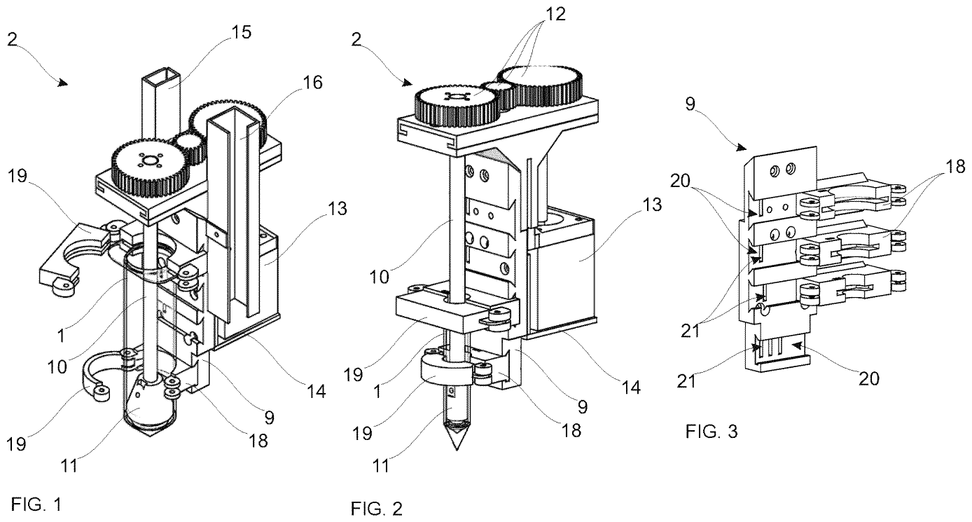

FIG. 1 is a perspective view of a printing head suitable for use with the invention.

FIG. 2 is a perspective view of a printing head suitable for use with the invention.

FIG. 3 is a perspective view of the body of a printing head suitable for use with the invention.

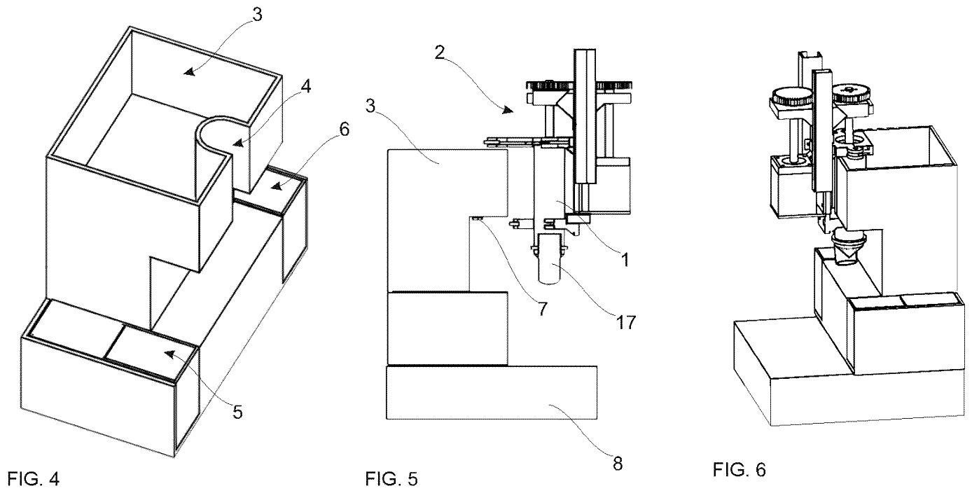

FIG. 4 is a perspective view of an ultrasonication unit according to the invention.

FIG. 5 is a perspective view of an ultrasonication unit according to the invention together with a printing head.

FIG. 6 is a perspective view of an ultrasonication unit according to the invention during use.

The parts in the figures are numbered individually, and the corresponding descriptions are given below.
1. Syringe
2. Printing head
3. Tank
4. Application surface
5. Cleaner tank
6. Waste tank
7. Control switch
8. Table
9. Body
10. Trapezoidal shaft
11. Piston
12. Gear
13. Motor
14. Connection bracket
15. Cable duct
16. Pipe duct
17. Blower
18. First clamp piece
19. Second clamp piece
20. Rail
21. Locking hole

The ultrasonication unit of the invention for use with three-dimensional printers comprising a printing head (2) which enables the production of foodstuffs in fluid or paste form by additive manufacturing applications and which enables the material contained in a syringe (1) to be deposited by means of controlling the position of a piston (11) in the syringe (1) and positioning the syringe (1), essentially comprises
a tank (3),
a liquid contained in the tank (3),
at least one vibration motor acting on an area on the surface of the tank (3), and
at least one application surface (4) forming a region having a concave shape on the outer surface of the tank (3) onto which the surface of the syringe (1) can at least partially fit.

Vibration motors preferably produce vibrations at ultrasonic frequencies. Vibration motors operating at different frequencies can be used. The ultrasonication unit also includes a control unit that drives the vibration motors.

The liquid in the tank (3) ensures that the vibration generated by the vibration motor is transferred through the tank (3) to the application surface (4). The liquid can be selected according to the operating frequency of the vibration motor used. The top of the tank (3) can be open or closed. The tank (3) may comprise mechanically or electronically controlled valves for filling and emptying the liquid. The filling and emptying operations can be carried out by an operator, either manually or according to operator input, or by means of a control system operating automatically.

The vibration distributed over the entire application surface (4) by means of the liquid generates a secondary vibration along the application surface (4) in a direction perpendicular to the application surface (4), and the energy transmission by vibrations is guided depending on the shape of the application surface (4). Thanks to the shape of the application surface (4) to fit on the surface of the syringe (1), it ensures that both the vibrations are focused on the syringe (1) and the energy transmission by vibration is carried out with a uniform distribution throughout the volume of the syringe (1).

The application surface (4) preferably has the shape of a curved surface of a half-cylinder to allow free insertion and removal of a standard shaped syringe (1) and to provide the largest contact surface area for the transmission of vibration. In order that the elements for connecting the syringe (1) to the pressure head (2) and protruding from the surface of the syringe (1) do not interfere with the fitting of the syringe (1) to the application surface (4), corresponding gaps may also be formed. These gaps may be provided in the application surface (4). Instead, as in the exemplary embodiment shown in FIG. 4-6, the application surface (4) may be positioned on a part of the container (3) forming a protrusion. Thus, these gaps may also be located in the periphery of the application surface (4). In a preferred embodiment of the invention, the application surface (4) corresponds to the dimensions of the largest syringe (1) expected to be used with the printer. In this case, with the movement of the syringe (1) and the application surface (4) relative to each other vertically, the part of the syringe (1) close to the tip is aligned to the application surface (4), and vibrations can be transferred to the syringe (1) by fitting this part to the application surface (4).

The inventive ultrasonication unit can be fixed to a three-dimensional printer. In an exemplary embodiment of the invention, the ultrasonication unit is connected to the table (8) defining the printing surface of the printer. For this purpose, magnetic connection parts can be used.

The ultrasonication unit comprises at least one cleaner tank (5) and at least one waste tank (6). In case there is one cleaner tank (5), this cleaner tank (5) is filled with water. When the printer is operated according to a cleaning protocol, the printing head (2) is positioned over the cleaner tank (5), water from the cleaner tank (5) is drawn into the syringe (1), the printing head (2) is positioned so that the syringe (1) is placed on the application surface, the vibration motors are operated for a predetermined time, the printing head (2) is positioned over the waste tank (6) and the dirty water in the syringe (1) is discharged. These operations can be repeated as many times as desired. The ultrasonication unit may include two cleaner tanks (5), one filled with water and one filled with detergenated water. In this case, separate procedures for washing and rinsing the syringe (1) can be defined within the cleaning protocol. The filling and emptying of the cleaner reservoir (5) and the waste reservoir (6) can be carried out manually by the operator or by means of a control system that operates according to operator input or automatically.

Besides the cleaning of the syringe (1), the ultrasonication unit allows for the mixing and homogenisation of substances containing components that tend to separate by settling or floating in the syringe (1) prior to deposition.

The ultrasonication unit may further comprise at least one control switch (7) for checking the correct positioning of the syringe (1) prior to starting the vibration motors. For this purpose, the control switch (7) is positioned on the tank (3) such that it is triggered by the syringe (1) when the syringe (1) is fitted on the application surface (4).

The ultrasonication unit according to the invention can be used in combination with printers having a piston (11) melt extruder and a printing head (2) to which a syringe (1) can be attached for use with viscous foodstuffs. This printing head (2) can be connected to a two-or three-axis linear motion mechanism by means of a connection bracket (14). In the case of a two-axis linear travelling mechanism, a second linear travelling mechanism is provided for the movement of the table (8) in the third axis. The materials in the syringe (1) can be deposited on the table (8), on an object positioned on the table (8) or on the previous layer deposited by pushing the piston (11) moved by means of a trapezoidal shaft (10).

The printing head (2) is also provided with a blower (17), which is positioned on the printing head (2) next to the nozzle (1) of the syringe (1) and through which a gas is delivered to the deposited material in order to cool, heat, humidify, dry, retard oxidation or achieve other effects on the deposited material.

The trapezoidal shaft (10) is driven by a motor (13). The trapezoidal shaft (10) is connected to the motor (13) by a series of gears (12). The motor (13) is preferably a stepper motor. The trapezoidal shaft (10) can be connected to the motor (13) by another drive train, such as a belt and pulley system, or directly.

The printing head (2) comprises a body (9) carrying clamps for securing a syringe (1), a motor (13), a trapezoidal shaft (10), gears (12), a mounting bracket (14) and a blower (17). On the sides of the body (9) there are also a cable duct (15) and a pipe duct (16) for the organised storage of cables and pipes connected to the blower (17).

The clamps comprise a first clamp piece (18) and a second clamp piece (19) having a semicircular inner surface. In a preferred embodiment of the invention, the clamps are removable so that syringes (1) of different sizes can be connected to the printing head (2).

Thus, the clamp having a size suitable for the size of the syringe (1) to be used can be connected to the body (9). For this purpose, there are rails (20) on the body (9) in which the first clamp pieces (18) are slidably inserted. In order that the first clamp pieces (18) can be inserted into the rails (20) in such a way that they do not move in a direction perpendicular to the direction defined by the respective rail (20), each rail (20) has a cross-section widening with distance from the surface of the body (9). The first clamp pieces (18) also have a cross-section which precisely fits into this cross-section of the rails (20). After the first clamp pieces (18) are slidably positioned along the direction defined by the respective rails (20), the first clamp pieces (18) and the rails (20) are provided with opposing locking elements to prevent unwanted movement along this direction. For example, the rails (20) can be fixed on the body (9) by means of a locking hole (21) located on each rail (20), an opposing hole located at the base of each first clamp piece (18), and a locking pin passed together through the locking hole (21) and an opposing hole, and the rails (20) can be fixed on the body (9).

What is claimed is:

1. An ultrasonication unit for use with three-dimensional printers comprising a printing head, wherein the printing head enables material contained in a syringe to be deposited by means of controlling a position of a piston in the syringe and positioning the syringe, comprising
a tank,
a liquid contained in the tank,
at least one vibration motor acting on an area on a surface of the tank, and
at least one application surface forming a region having a concave shape on an outer surface of the tank where a surface of the syringe is configured to at least partially fit.

2. The ultrasonication unit according to claim 1, comprising the at least one vibration motors producing vibrations at ultrasonic frequencies.

3. The ultrasonication unit according to claim 1, comprising the application surface having a shape of a curved surface of a half-cylinder.

4. The ultrasonication unit according to claim 1, comprising at least one cleaner tank and at least one waste tank.

5. The ultrasonication unit according to claim 1, comprising at least one control switch positioned on the tank, wherein the at least one control switch is triggered by the syringe when the syringe is fitted on the application surface.

6. A three-dimensional printer for enabling production of foodstuffs in fluid or paste form by additive manufacturing applications comprising
a printing head connected to a two- or three-axis linear motion mechanism, wherein the printing head enables material contained in a syringe to be deposited,
a body incorporated in the printing head,
an attachment bracket incorporated in the printing head and connecting the body to the two- or three-axis linear motion mechanism,
a piston incorporated in the printing head for pushing the materials in the syringe, wherein the piston is moved by means of a trapezoidal shaft,
a motor incorporated in the printing head and driving the trapezoidal shaft,
clamps incorporated in the printing head and securing the syringe comprising an ultrasonication unit having
a tank,
a liquid contained in the tank,
at least one vibration motor acting on an area on a surface of the tank, and
at least one application surface forming a region having a concave shape on an outer surface of the tank where a surface of the syringe is configured to at least partially fit.

7. The three-dimensional printer according to claim 6, comprising the at least one vibration motors producing vibrations at ultrasonic frequencies.

8. The three-dimensional printer according to claim 6, comprising the application surface having a shape of a curved surface of a half-cylinder.

9. The three-dimensional printer according to claim 6, comprising at least one cleaner tank and at least one waste tank.

10. The three-dimensional printer according to claim 6, comprising at least one control switch positioned on the tank, wherein the at least one control switch is triggered by the syringe when the syringe is fitted on the application surface.

11. A three-dimensional printer for enabling production of foodstuffs in fluid or paste form by additive manufacturing applications comprising
a printing head connected to a two- or three-axis linear motion mechanism, wherein the printing head enables material contained in a syringe to be deposited,
a body incorporated in the printing head,
an attachment bracket incorporated in the printing head and connecting the body to the two- or three-axis linear motion mechanism,
a piston incorporated in the printing head for pushing the materials in the syringe, wherein the piston is moved by means of a trapezoidal shaft,
a motor incorporated in the printing head and driving the trapezoidal shaft,
clamps incorporated in the printing head and securing the syringe, having a first clamp piece and a second clamp piece having a semicircular inner surface comprising
rails on the body where the first clamp pieces are slidably inserted and each having a cross-section widening with distance from a surface of the body,
the first clamp pieces having a cross-section, wherein the cross-section precisely fits into the cross-section of the rails.

12. The three-dimensional printer according to claim 11, comprising opposing locking elements on the first clamp pieces and the rails.

13. The three-dimensional printer according to claim 12, comprising a locking hole located on each rail, an opposing hole located at a base of each first clamp piece, and a locking pin passed together through the locking hole and an opposing hole.

14. The three-dimensional printer according to claim 11, comprising a series of gears connecting the trapezoidal shaft to the motor.

15. The three-dimensional printer according to claim 11, comprising a blower positioned on the printing head next to a nozzle of the syringe and where a gas is delivered to deposited material.

16. The three-dimensional printer according to claim 15, comprising a cable duct for holding cables and a pipe duct for holding pipes connected to the blower, located on the sides of the body.
